(19) United States
(12) Patent Application Publication
(10) Pub. No.: US 2014/0318466 A1
(43) Pub. Date: Oct. 30, 2014

(54) AQUARIUM HAVING FILTERING FUNCTION

(71) Applicant: Golden Orange Co., Ltd., Daedeok-gu Daejeon (KR)

(72) Inventor: Guen Ha Park, Chungcheongnam-do (KR)

(73) Assignees: Golden Orange Co., Ltd., Daejeon (KR); Guen Ha PARK, Geumsan-gun, Chungcheongnam-do (KR)

(21) Appl. No.: 14/366,685

(22) PCT Filed: Jan. 8, 2013
(86) PCT No.: PCT/KR2013/000124

§ 371 Date: Jun. 19, 2014

(30) Foreign Application Priority Data
Jan. 9, 2012 (KR) 10-2012-0002430

(51) Int. Cl. A01K 63/04; A01K 63/00

(52) U.S. Cl. CPC A01K 63/045; A01K 63/003
USPC 119/259

(57) ABSTRACT

The present invention relates to an aquarium having a filtering function so as to facilitate the growth of aquatic organisms such as fish, crustaceans, shellfishes, and aquatic plants. According to the present invention the aquarium having a filtering function is configured to include: a porous horizontal partition wall which horizontally partitions the inner space of the aquarium into an upper growing region and a lower filtering region; and a filtering device which is disposed at a predetermined portion of the horizontal partition wall and provided with a filter so as to suction and filter water in the growing region and discharge the water to the filtering region. The water, whose pollutants are filtered using the filtering device, is allowed to move through the pores of the horizontal partition wall from the lower portion to the upper portion of a floor material, such as sand or a functional material, which is stacked on the upper surface of the horizontal partition wall. As a result, pollutants concentrated between the grains of the floor material are floated using the water in the growing region, and the water containing the floated pollutants is absorbed back by the filtering device in order to be filtered.

### TECHNICAL FIELD

The present invention relates to an aquarium having a filtering function so as to facilitate the growth of aquatic organisms such as fish, crustaceans, shellfishes, and aquatic plants, and more particularly, to an aquarium having a filtering function is configured to include: a porous horizontal partition wall which horizontally partitions the inner space of the aquarium into an upper growing region and a lower filtering region; and a filtering device which is disposed at a predetermined portion of the horizontal partition wall and provided with h a filter so as to suction and filter water in the growing region and discharge the water to the filtering region.

### BACKGROUND ART

In general, a fishbowl or an aquarium is installed, which grows various types of fishes in order to environmentally friendly decorate the insides of public facilities such as homes, offices, schools, or hospitals.

However, as fishes which are grown in an artificial space live in a limited space, when the fishbowl or the aquarium is not frequently cleaned or is improperly maintained due to pollutants such as feed grains and excreta of the fishes or improper maintenance.

Therefore, it is necessary to create a beneficial ecological environment in which the fishes can survive by installing a filter, an oxygen supplier, and the like which are artificial water purification equipments and removing some of the pollutants.

However, in general water purification filtering schemes, mainly, the artificial purification equipments are installed on the side, the top, or the bottom of the aquarium or a separate external filter is externally installed.

However, in such a filtering scheme, it is difficult to circulate water in the entire aquarium and in particular, a problem that it is difficult to effectively remove pollutants concentrated in sand on the floor, the excreta are precipitated in the sand and decomposed or re floated by bubbles of the oxygen supplier to make water in the aquarium be murky. As a result, it is limitative in activation of microorganisms that decompose a toxic material.

Further, since filtering devices are installed in a growing region, an aesthetic problem and inconvenience that filters should be replaced or the filter should be taken out and reinstalled every cleaning occur, and as a result, consistent research and development for solving the problem and the inconvenience are required.

### DETAILED DESCRIPTION OF THE INVENTION

### Technical Problem

The present invention as technology contrived to enhance problems of an aquarium in the related art and a problem occurs, in which in an aquarium having a filtering function in the related art, water in the aquarium is filtered by a method that sucks only water positioned on the top of a floor material and makes the sucked water to pass through a filtering device, and as a result, pollutants are stacked on the top of the floor material or between grains of the floor material, a predetermined water inlet is provided on the bottom of the floor material to adsorb feed grains or excreta of fishes, and configured to wash a floor material adsorbed with a lot of pollutants, a problem occurs in which managing the aquarium is not easy because a washing cycle of the floor material is shortened, and as a result, a main object of the present invention is to provide a solution point.

### Means for Solving the Problem

In order to implement the object, the present invention presents an aquarium having a filtering function which is configured to include a porous horizontal partition in which an inner space of an aquarium, which has a predetermined shape is horizontally partitioned into an upper growing region and a lower filtering region and a floor material is stacked on the top; and a filtering device which is mounted on a predetermined portion of the horizontal partition, is provided with a filter, and sucks and filters water in the growing region to discharge the sucked and filtered water to the filtering region.

### Effect of the Invention

In an aquarium having a filtering function according to the present invention presented as above, water filtered with pollutants by a filtering device is movable from the bottom to the top of a floor material (hereinafter, referred to as a ‘floor material’) such as sand or a functional material stacked on the top of a horizontal partition through porosities of the horizontal partition, and as a result, pollutants concentrated between grains of the floor material are floated by a growing region and water including the floated pollutants is again sucked by the filtering device to be filtered.

### BRIEF DESCRIPTION OF DRAWINGS

FIG. 1 is a perspective view illustrating an aquarium having a filtering function according to a preferred embodiment of the present invention.

FIG. 2 is a perspective view illustrating a horizontal partition and a filtering device of the aquarium having the filtering function according to the preferred embodiment of the present invention.

FIG. 3 is a cross-sectional perspective view illustrating the filtering device of the aquarium having the filtering function according to the preferred embodiment of the present invention.

FIG. 4 is an exploded perspective view illustrating the filtering device of the aquarium having the filtering function according to the preferred embodiment of the present invention.

FIGS. 5(a) and 5(b) are exploded perspective views illustrating a horizontal partition of the aquarium having the filtering function according to the preferred embodiment of the present invention.

FIG. 6 is an exploded perspective view illustrating an assembly procedure of the horizontal partition of the aquarium having the filtering function according to the preferred embodiment of the present invention.

FIG. 7 is another exploded perspective view illustrating the assembly procedure of the horizontal partition of the aquarium having the filtering function according to the preferred embodiment of the present invention.

FIG. 8 is yet another exploded perspective view illustrating the assembly procedure of the horizontal partition of the aquarium having the filtering function according to the preferred embodiment of the present invention.

FIGS. 9 and 10 are side cross-sectional views illustrating the aquarium having the filtering function according to the preferred embodiment of the present invention.

FIGS. 11 and 12 are plan views illustrating the aquarium having the filtering function according to the preferred embodiment of the present invention.

FIGS. 13 and 14 are side cross-sectional views illustrating a case in which the aquarium having the filtering function according to the preferred embodiment of the present invention includes an auxiliary aquarium.

### MODE FOR CARRYING OUT THE INVENTION

The present invention relates to an aquarium having a filtering function, which allows aquatic organisms (hereinafter, referred to as ‘fish’) such as fishes, crustaceans, shellfishes, or aquatic plants, and to an aquarium having a filtering function, which includes: a porous horizontal partition 30 in which an inner space of an aquarium 100, which has a predetermined shape is horizontally partitioned into an upper growing region 10 and a lower filtering region 11 and a floor material 12 is stacked on the top; and a filtering device 40 which is mounted on a predetermined portion of the horizontal partition 30, is provided with h a filter 43, and sucks and filters water in the growing region 10 to discharge the sucked and filtered water to the filtering region 11.

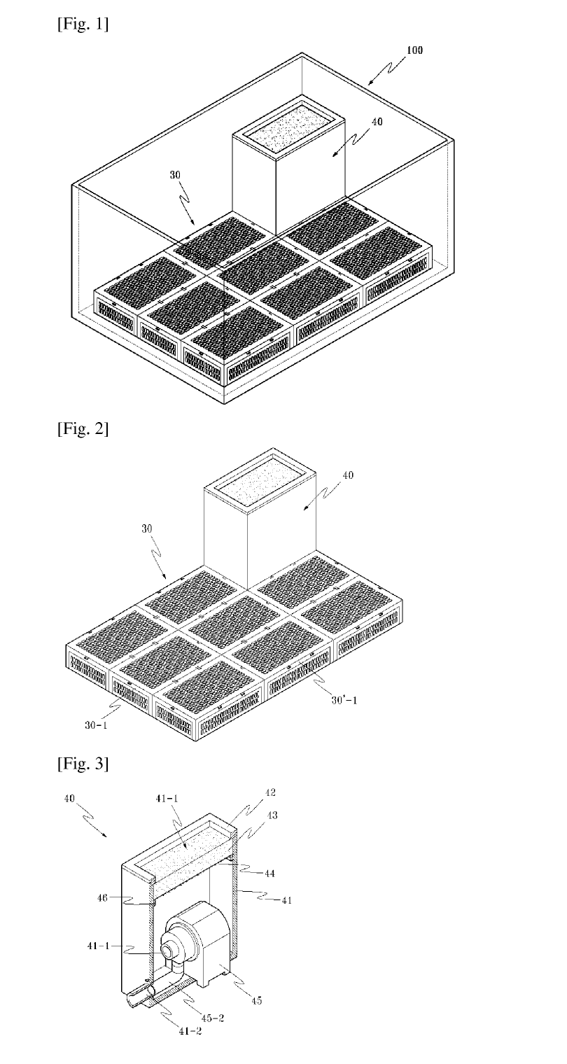

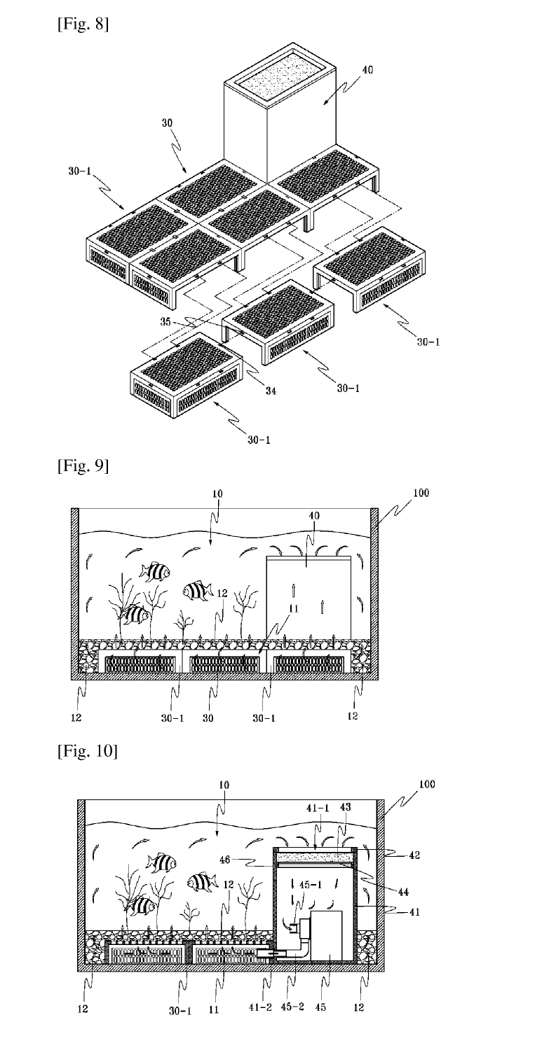

Hereinafter, the present invention will be described below in detail with reference to FIGS. 1 to 14 illustrating an embodiment of the present invention.

In detail, the aquarium 100 as a general aquarium 100 having a predetermined shape may have even any configuration if the aquarium 100 is capable of receiving a predetermined amount of water and has a general floor material 12 which is stackable on the floor of an inner surface, such as sand or a functional material.

Moreover, the horizontal partition 30 as a porous partition that horizontally partitions the inner space of the aquarium 100 and has the floor material 12 staked on the top thereof has a configuration in which the top has a predetermined area and includes porosities having a size as large as the floor material 12 may not pass to separate filtered water which exists in the filtering region 11 corresponding to a lower part of the horizontal partition 30 and unfiltered water which exists in the growing region 10.

Further, the horizontal partition 30 is configured to have the size of the top which is the same as that of a horizontal plane of the inner space of the aquarium 100, and as a result, the horizontal partition 30 may be configured to closely fit in the inner space, but as illustrated in FIGS. 9 to 12, the horizontal partition 30 is preferably configured to have a smaller size than the horizontal plane of the inner space so as to maintain a predetermined gap between the outer periphery of the horizontal partition 30 and the inner periphery of the inner space. This is to implement an effect in which the floor material 12 is stacked in a gap between the outer periphery of the horizontal partition 30 and the inner periphery of the inner space, and as a result, the horizontal partition 30 is covered by the floor material 12 and the horizontal partition 30 is thus not shown from the outside of the aquarium 100 to improve an aesthetic sense.

In this regard, a lateral plane of the horizontal partition 30 is configured to be closed, and as a result, the growing region 10 and the filtering region 11 corresponding to the lateral surface of the horizontal partition 30 may be fully separated, but the lateral plane is configured to be porous like the top to supply the filtered water to the floor material 12 positioned between the outer periphery of the horizontal partition 30 and the inner periphery of the inner space.

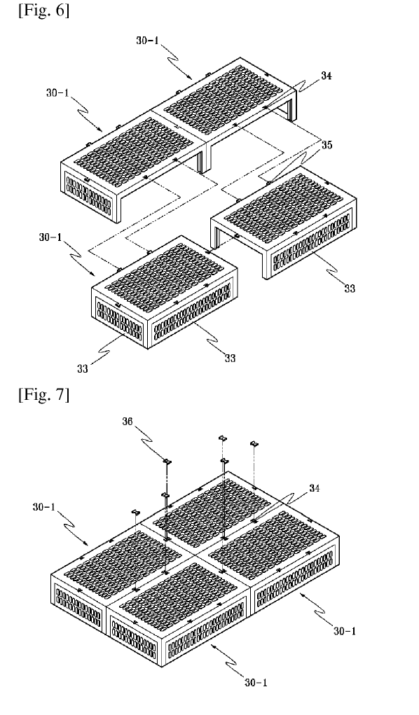

Moreover, if the horizontal partition 30 according to the present invention is configured to separate the growing region 10 and the filtering region 11 and supply the filtered water in the filtering region 11 to the growing region 10, the horizontal partition 30 may have even any shape, but as illustrated in FIGS. 5 to 7, the horizontal partition 30 is configured to include a plate-like horizontal plate 31 having a horizontal direction to the bottom (the same concept as the horizontal plane); a plurality of supporters 32 provided at predetermined portions of a lower outer periphery of the horizontal plate 31; and a side plate 33 of which both sides are joined between one supporter 32 and the other supporter 32 which are adjacent to each other, and a plurality of horizontal partitions 30-1 configured to include the horizontal plate 31, the supporter 32, and the side plate 33 may be horizontally joined to each other.

Further, the supporter 32 has a predetermined height and a plurality of supporters 32 are provided at predetermined portions of the lower outer periphery of the horizontal plate 31 and has a height of the filtering region 11 as the height of the horizontal plate 31 formed by the supporter 32 and provides support force to stably seat the horizontal plate 31 on the bottom of the inner space of the aquarium 100.

In addition, the side plate 33 as the component of which both side ends are joined between one supporter 32 and the other one supporter 32 which are adjacent to each other provides an effect to improve the support force of the horizontal plate 31 by the supporter 32. In this case, the side plate 33 provides even an effect to move the water in the filtering region 11 toward the floor material 12 of the growing region 10 positioned between the outer periphery of the horizontal partition 30 and the inner periphery of the inner space when the porosities are provided on the side plate 33.

In this regard, the horizontal partition 30 according to the present invention may be configured by one horizontal partition 30 that includes the horizontal plate 31, the supporter 32, and the side plate 33 and has a similar size as the area of the horizontal plane of the inner space of the aquarium 100, but as illustrated in FIGS. 6 to 8, the horizontal plate 31 having a smaller size than the area of the horizontal plane of the inner space of the aquarium 100 and a plurality of horizontal partitions 30-1 configured to include the supporter 32 and the side plate 33 joined to the horizontal plate 31 are more preferably joined in plural horizontally.

That is, the plurality of horizontal partitions 30-1 having such a configuration generally provides an effect in which the plurality of horizontal partitions 30-1 are joined to be adjacent to each other according to the judgment by those skilled in the art to ensure a flexible size of the horizontal partition 30 with respect to the aquarium 100 having different sizes.

Further, the horizontal partitions 30-1 adjacent to each other are preferably joined to each other in a scheme in which a plurality of predetermined joining grooves 34 and joining protrusions 35 are selectively provided on the outer periphery of the top of the horizontal partition 30-1 as illustrated in FIG. 6, and as a result, the adjacent joining protrusion 35 of the horizontal partition 30-1 is joined to the joining groove 34 of one horizontal partition 30-1. In this case, the shapes of the joining groove 34 and the joining protrusion 35 may be arbitrarily selected as a trapezoidal shape, a circular shape, or an oval shape.

Moreover, only the plurality of joining grooves 34 are provided on the outer peripheries of the tops of the adjacent horizontal partitions 30-1 as illustrated in FIG. 7 and may be configured by a scheme in which joining mechanisms 36 capable of joining the adjacent joining grooves 34 fit in grooves formed by the adjacent joining grooves 34. In this case, if the joining mechanism 36 fits in grooves formed by a pair of joining grooves 34 adjacent to each other to firmly join the adjacent horizontal partitions 30-1, the joining mechanism 36 may have even any shape.

In this regard, in the present invention in which the plurality of horizontal partitions 30-1 are joined to each other to constitute one horizontal partition 30, among the horizontal partitions 30, only the side plate 33 of the horizontal partition 30-1 corresponding to an outer periphery part (a part adjacent to the floor material 12) of the horizontal partition 30-1 positioned outside the horizontal partition 30 and among the horizontal partitions 30, the side plate 33 of the horizontal partition 30-1 positioned inside the horizontal partition 30 is not provided to prevent the flow of the filtered water moved in the filtering region 11 formed at a part corresponding to a lower position of the horizontal plate 31 integrally formed from being interrupted by the side plate 33 of the horizontal partition 30-1 positioned inside the horizontal partition 30 among the horizontal partitions 30.

Further, joining between the pair of supporters 32 and both ends of the side plate 33 may be configured to completely fix the supporters 32 and the side plate 33 and as illustrated in FIGS. 5(a) and 5(b), the supporters 32 and the side plates 33 are preferably configured to be separated and joined.

In detail, in the present invention as illustrated in FIG. 5(a), the supporter 32 is configured to include a support groove 32-1a having a predetermined depth on an inter-opposed surface between the pair of supporters 32 adjacent to each other in a height direction, the side plate 33 is configured to include a support protrusion 33-1a joined to the support groove 32-1a on both side portions of the side plate 33, and the support protrusion 33-1a at both side ends of the side plate 33 are configured to be slidably to the support groove 32-1a of the supporter 32.

That is, the support groove 32-1a configured in the supporter 32 as a component that has a predetermined depth on the outer peripheral surface of the supporter 32 and is provided in a height direction from the end of the supporter 32 shows an effect in which the support protrusion 33-1a of the side plate 33 is received by the end (an opposite part of the horizontal plate 31) of the supporter 32 and the side plate 33 is slid (pushed) slides toward the horizontal plate 31 to firmly join the side plate 33 to the supporter 32. In this case, it will be apparent that the support groove 32-1a is configured to have a structure in which a direction where the side plate 33 is positioned is opened.

Further, the support protrusion 33-1a slidably joined to the support groove 32-1a is configured to be provided at both ends of the side of the side plate 33 and if the support protrusion 33-1a has a similar length as the support groove 32-1a of the supporter 32 to be correspondingly joined to the support groove 32-1a, the support protrusion 33-1a may have even any configuration.

Moreover, in the present invention, as illustrated in FIG. 5(b), the supporter 32 is configured in such a manner that one or more trapezoidal, circular, or oval support grooves 32-1b are provided at predetermined portions where both side ends of the side plate 33 are positioned, respectively, the side plate 33 is configured in such a manner that one or more support protrusions 33-1b correspondingly joined to the support grooves 32-1b, respectively are provided at both side ends of the side plate 33, the support protrusions 33-1b at both side ends of the side plate 33 are configured to be fittably joined to the support grooves 32-1b of the supporter 32 to configure the supporter 32 and the side plate 33 to be separated and joined.

That is, since the support grooves 32-1b configured in the supporter 32 which correspond to outside external surfaces of the supporter 32 and provided at predetermined portions where both side ends of the side plate 33 are positioned, respectively to horizontally receive the support protrusions 33-1b of the side plate 33 and have a trapezoidal, circular, or oval shape, the support grooves 32-1b may maintain a firm joining state with the support protrusion 33-1b having a shape corresponding to the shape and since a joining surface is small, separation also implements an easy effect.

Further, one or more support protrusion 33-1b are provided at both side ends of the side plate 33 to horizontally fit in the support grooves 32-1b and have the same shape and size as the support grooves 32-1b and are configured at predetermined positions on the side of the side plate 33 which correspond to positions corresponding to the support grooves 32-1b.

Moreover, if a filtering device 40 according to the present invention is configured to be mounted at a predetermined portion of the horizontal partition 30 and provided with a filter 43 to suck and filter water in the growing region 10 and discharge the filtered water to the filtering region 11, and configured to have a predetermined height from the bottom of the inner space of the aquarium 100 as illustrated in FIG. 1, 2, or 9, and is configured to be mounted at a predetermined portion of the horizontal partition 30 to suck the water in the upper growing region 10 and filter the sucked water by the filter 43, and discharge the filtered water to the filtering region 11, the filtering device 40 may have even any configuration.

In detail, the filtering device 40 according to the present invention is preferably configured to include: a hollow case 41 having a predetermined portion on an outer periphery at a predetermined portion of the horizontal partition 30, an inlet 41-1 for suck the water in the growing region 10 provided at an upper portion, and an outlet 41-2 for supplying the filtered water to the filtering region 11 provided at a lower portion; a filter 43 inserted into a hollow corresponding to the inlet 41-1 of the case 41 to filter the sucked water; a blocking net 44 having a plurality of bent pipes with a predetermined size and making the filtered water to penetrate in abutment of the bottom and the top of the filter 43; and a pump 45 which is positioned at a predetermined portion in the bottom direction of the blocking net, and is provided with a pump suction pipe 45-1 to suck the water penetrating the blocking net 44 and is provided with a pump discharge pipe 45-2 to discharge the water to the outlet 41-2 of the case 41.

That is, the hollow case 41 is configured to implement for sequentially receiving the filter 43, the blocking net 44, and the pump 45 included in the filtering device 40 toward the outlet 41-2 provided at the other side of the case 41 which is the part (filtering region 11) corresponding to the bottom of the inner space of the aquarium 100 from the inlet 41-1 provided at one side of the case 41 which is the part (growing region 10) corresponding to a water level surface.

In this case, the case 41 may have a size enough to receive the hollow filter 43, the blocking net 44, and the pump 45, but the case 41 is configured to have a horizontal length and a vertical length which are the same as a horizontal length and a vertical length forming a horizontal cross section of the horizontal plate 31, and the case 41 more preferably include a joining groove 34 or a joining protrusion 35 which may be correspondingly joined to a joining groove 34 or a joining protrusion 35 provided in the horizontal partition 30 so that the case 41 of which a predetermined portion on the outer periphery is mounted on a predetermined portion of the horizontal partition 30 is integrally joined to the horizontal partition 30.

Further, the inlet 41-1 is provided on the top of the case 41 which is the part corresponding to the water level surface to suck water including the pollutant of the growing region 10, and is configured in a comparatively large hole form to suck the water including the pollutant in the growing region 10, but as illustrated in FIGS. 1 to 3, the inlet 41-1 is preferably configured to have a similar size as the top end of the case 41 to suck water of the pollutant corresponding to a wide area.

Moreover, the filter 43 is inserted into a predetermined hollow portion corresponding to the inlet 41-1 of the case 41 to filter the pollutant in the water including the pollutant sucked in the inlet 41-1 and if the filter 43 includes a plurality of holes to make the water to penetrate the pump 45 and block the pollutant, even any filter may be used as the filter 43. In this case, it will be apparent that the filter 43 may have a free size in a hollow of the case 41 and the filter 43 is separable toward the inlet 41-1 from the hollow of the case 41, and as a result, the filter 43 which is adsorbed with a lot of pollutants due to consistent use is pulled out from the case 41 to be replaced or washed.

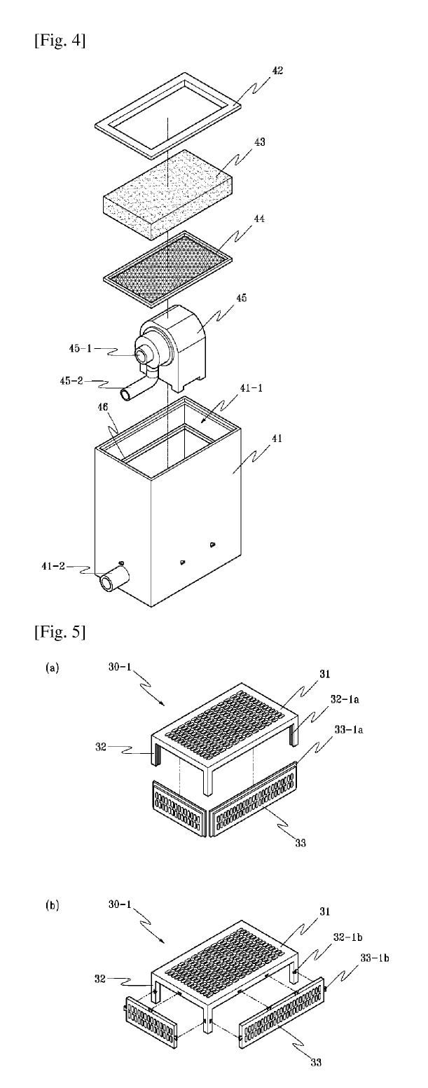

Further, in order to stably join the filter 43 to the case 41 or easily separate the filter 43 from the case 41, a hollow cover 42 may be joined to the end of the case 41 corresponding to the upper part of the case 41 and the top of the filter 43 as illustrated in FIG. 4. In this case, the cover 42 is preferably configured to join a predetermined portion of the top of the filter 43 to the end of the case 41 while pressing the predetermined portion toward the blocking net 44.

In this regard, the blocking net 44 is configured to have a plurality of vent pipes having a predetermined size as illustrated in FIG. 4 and make the filtered water to be penetrated due to abutment of the bottom and the top of the filter 43 and when a user separates the filter 43 from the case 41 in order to replace or wash the filter 43, the blocking net 44 is configured to prevent the fishes that grow in the inner space of the aquarium 100 from entering the inside of the hollow of the case 41 in which the pump 45 is positioned.

In this case, if the blocking net 44 is configured to have a vent pipe having such a size that the fishes cannot pass and be mounted on a predetermined height portion (the upper portion of the pump 45) of the hollow of the case 41, the blocking net 44 may have even any configuration, but the blocking net 44 may be preferably configured by a ring-type edge frame which may be suspended to a suspension jaw provided at a predetermined portion on the inner periphery of the hollow of the case 41 and a blocking net provided inside the edge frame as illustrated in FIGS. 3 and 4.

Further, the pump 45 is positioned both inside the hollow of the case 41 and t a predetermined portion in the bottom direction of the blocking net 44, the pump 45 is provided with a pump inlet 45-1 to suck the water penetrating the blocking net 44 and provided with a pump outlet 45-2 to discharge the water to the outlet 41-2 of the case 41, and as the pump 45, water pumps having various capacities may be used among general water pumps 45 according to a judgment by those skilled in the art.

In this regard, the end of a suction hole of the pump inlet 45-1 may be positioned even at any portion of the hollow of the case 41 corresponding to the top of the blocking net 44 as illustrated in FIG. 3 or 10. In this case, an incoming hole that may embrace an area of the bottom of the blocking net 44 is joined to the bottom of the blocking net 44 according to the judgment by those skilled in the art and the filtering device 40 further includes an auxiliary case 41 (not illustrated) in which an outgoing hole is joined to the end of the suction hole of the pump inlet 45-1, and as a result, the water penetrating the blocking net 44 may be configured to be sucked into the pump inlet 45-1 more smoothly.

Further, the pump outlet 45-2 of the pump 45 is configured to discharge water pumped by the pump 45 to the outside of the case 41 through the outlet 41-2 of the case 41 serves as the pump outlet 45-2 of the general pump 45.

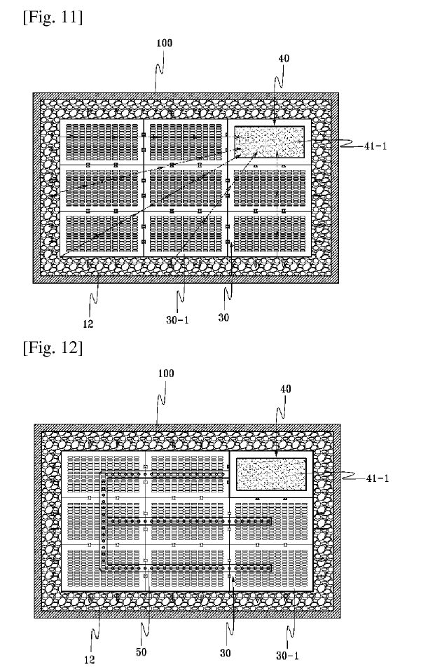

That is, the filtered water discharged to the outside of the case 41 through the outlet 41-2 of the filtering device 40 according to the present invention is moved to the filtering region 11 at predetermined transfer force and the water in the filtering region 11 moves the pollutant adsorbed to the inside of the floor material 12 through porosities provided in the horizontal partition 30 while making the growing region 10 float at internal water pressure of the filtering region by the transfer force. Further, the pollutant separated from the floor material 12 and floated to the growing region 10 is sucked into the inlet 41-1 of the filtering device 40 together water to be filtered as illustrated in FIG. 11.

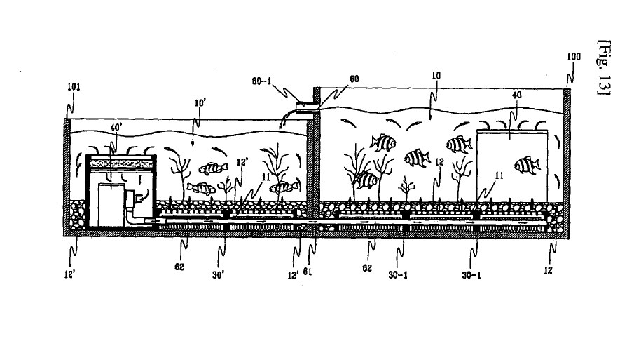

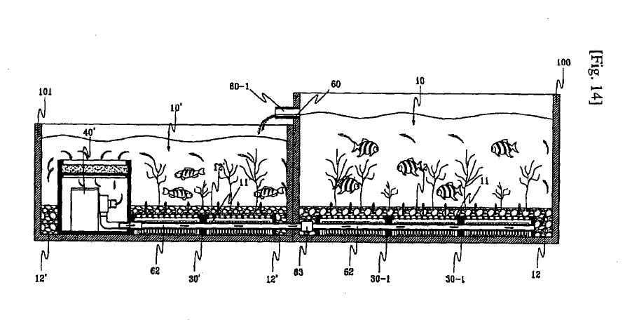

In addition, in the present invention, the filtered water discharged from the outlet 41-2 of the case 41 is transferred to an entire region of the filtering region 11, and a porous circulation pipe 50 having a predetermined extension length and predetermined refraction may be mounted on the end of the outlet 41-2 as illustrated in FIG. 12 in order to constantly maintain total water pressure of the filtering region 11. In this case, the extension length, a bending degree (refractive angle), and the size of the porosity of the circulation pipe 50 may be arbitrarily transformed according to the shape of the aquarium 100 and a forming direction of the porosity is preferably toward the horizontal partition 30.

Moreover, in the present invention, as illustrated in FIGS. 13 and 14, the aquarium 100 is configured to further include an auxiliary aquarium 101 having a lower water level surface than the aquarium 100 on any one side thereof, and a water stream movement hole 60 is provided at a predetermined portion corresponding to the water level surface of the aquarium 100 to allow the water in the aquarium 100 to flow into the auxiliary aquarium 101, a recovery hole 61 that receives the water from the auxiliary aquarium 101 and is connected with the filtering region 11 of the aquarium 100 is provided at a predetermined lower side position, the auxiliary aquarium 101 includes a porous horizontal partition 30′ that horizontally partitions an inner space of the auxiliary aquarium 101 having a predetermined shape into an upper growing region 10′ and a lower filtering region 11′, and a filtering device 40′ that is mounted on a predetermined portion of the horizontal partition 30′ and is provided with a filter to suck and filter water in the growing region 10′ and discharge the sucked and filtered water to the filtering region 11′, and the water discharged from the filtering device 40′ of the auxiliary aquarium 101 penetrates the filtering region 11′ of the auxiliary aquarium 101 and is supplied to the filtering region 11′ of the auxiliary aquarium 101 and the filtering region 11 of the aquarium 100 through a supply pipe 62 connected with the recovery hole 61.

Further, it is apparent that one or more auxiliary aquariums 101 may be provided, and when one or more auxiliary aquariums 101 are provided, a plurality of respective auxiliary aquariums 101 may be directly connected to one or more sides of the aquarium 100, and one auxiliary aquarium 101 may be connected to the aquarium 100 and other auxiliary aquariums 101 may be sequentially connected with different auxiliary aquariums 101.

Moreover, when the aquarium 100 according to the present invention further includes the auxiliary aquarium 101, fishes that cannot live in one aquarium may live separately in the aquarium 100 and the auxiliary aquarium 101 as illustrated in FIGS. 13 and 14.

In detail, the water stream movement hole 60 of the aquarium 100 is provided on any one side of the aquarium 100 joined with the auxiliary aquarium 101, that is, a predetermined portion corresponding to the water level surface of the aquarium 100 as illustrated in FIG. 13 and may make the water in the aquarium 100 to flow into the auxiliary aquarium 101 through a hole having a predetermined diameter. In this case, the diameter of the water stream movement hole 60 may be arbitrarily controlled according to the judgment by those skilled in the art.

Further, in the present invention, a water stream movement pipe 60-1 having a predetermined length, which protrudes toward the auxiliary aquarium 101 is provided in the water stream movement hole 60 to make the water that flows into the auxiliary aquarium 101 from the aquarium 100 to drop to the auxiliary aquarium 101 by a predetermined head to realize a display effect such as a waterfall and realize even an oxygen supply effect of the auxiliary aquarium 101 by the water which drops by the predetermined head.

In this regard, the water stream includes a filtering net having a predetermined mesh at any one side of both ends or in the hollow or includes porosities in a direction corresponding to the water level surface of the auxiliary aquarium 101 are provided in the water stream movement pipe 60-1 itself to filter a pollutant included in water that flows toward the auxiliary aquarium 101 from the aquarium 100.

Moreover, the recover hole 61 is provided at a predetermined lower portion on the side of the aquarium 100 to have a predetermined diameter to receive the water filtered by the filtering device 40′ of the auxiliary aquarium 101 again and make the received water flow to the filtering region 11 of the aquarium 100.

Further, since configurations and action effects of the horizontal partition 30′ and the filtering device 40′ included in the auxiliary aquarium 101 are the same as those of the horizontal partition 30 and the filtering device 40 of the partition 100, a detailed description of the horizontal partition 30′ and the filtering device 40′ of the auxiliary aquarium 101 will be substituted by a description of the aquarium 100.

That is, when circulation of water between the aquarium 100 and the auxiliary aquarium 101 according to the present invention is examined, the filtered water discharged from the filtering device 40′ of the auxiliary aquarium 101 flows to the filtering region 11 of the aquarium 100 through the supply pipe 62 of which one side is connected with the filtering device 40′ of the auxiliary aquarium 101 and the other side is extended to the filtering region 11 through the recovery hole 61 of the aquarium 100. Thereafter, the water that flows from the auxiliary aquarium 101 is moved from the filtering region 11 to the growing region 10, and as a result, a water level of the aquarium 100 is increased and the water in the growing region 10 of the aquarium 100 flows to the auxiliary aquarium 101 through the water stream movement hole 60 again. Thereafter, the filtering device 40′ of the auxiliary aquarium 101 shows the same configuration and action as the filtering device 40 mounted on the aquarium 100, and as a result, the water including the pollutant of the growing region 10 of the auxiliary aquarium 101 is sucked and filtered to be discharged to the filtering region 11 (supply pipe 62).

In this regard, it will be apparent that the supply pipe 62 includes porosities toward the horizontal partition 30′ of the auxiliary aquarium 101 in order to supply the filtered water to the filtering region 11′ of the auxiliary aquarium 101 and includes porosities toward the horizontal partition 30 of the aquarium 100 even in a part corresponding to the filtering region 11 of the aquarium 100.

In this case, the sizes of the porosities provided in the part corresponding to the filtering region 11′ of the auxiliary aquarium 101 and the porosities provided in the part corresponding to the filtering region 11 of the aquarium 100 may be larger than the porosities provided in the part corresponding to the filtering region 11 of the aquarium 100 by considering water transfer pressure up to the filtering region 11 of the aquarium 100.

Moreover, when the filtering device 40′ of the auxiliary aquarium 101 is not actuated, since the water in the filtering region 11 of the aquarium 100 may flow backward to the filtering region 11 of the auxiliary aquarium 101 through the water supply 62 due to a difference in water pressure caused by a predetermined water level difference, the aquarium 100 and the auxiliary aquarium 101 may further include a backflow preventing device 63 at a predetermined portion of the supply 62 as illustrated in FIG. 14.

Further, when the aquarium 100 according to the present invention is configured to further include the auxiliary aquarium 101, the aquarium 100 may not include the filtering device 40 configured in the aquarium 100 as illustrated in FIG. 14.

That is, when the aquarium 100 further includes the auxiliary aquarium 101, the water in the aquarium 100 and the auxiliary aquarium 101 are consistently circulated and the water in the aquarium 100 may be thus filtered by the filtering device 40′ provided in the auxiliary aquarium 101, and as a result, whether the aquarium includes the filtering device 40 may be arbitrarily determined according to the judgment by those skilled in the art.

The present invention has been described with reference the preferred embodiment of the present invention and the present invention is not limited to the embodiment and various changes can be made by those skilled in the art without departing from the spirit of the present invention through the embodiment.

1. An aquarium having a filtering function, comprising:
a porous horizontal partition 30 in which an inner space of an aquarium 100, which has a predetermined shape is horizontally partitioned into an upper growing region 10 and a lower filtering region 11 and a floor material 12 is stacked on the top; and
a filtering device 40 which is mounted on a predetermined portion of the horizontal partition 30, is provided with a filter 43, and sucks and filters water in the growing region 10 to discharge the sucked and filtered water to the filtering region 11,
wherein the horizontal partition 30 a plate-like horizontal plate 31 having porosities and a horizontal direction to the bottom of the aquarium 100; a plurality of supporters 32 provided at predetermined portions of a lower outer periphery of the horizontal plate 31; and a side plate 33 of which both sides are joined between one supporter 32 and the other supporter 32, respectively, and
a plurality of horizontal partitions 30-1 configured to include the horizontal plate 31, the supporter 32, and the side plate 33 are joined to each other horizontally.

2. The aquarium having a filtering function of claim 1, wherein
the supporter 32 is configured to include a support groove 32-1a having a predetermined depth on an inter-opposed surface between the pair of supporters 32 adjacent to each other in a height direction, the side plate 33 is configured to include a support protrusion 33-1a joined to the support groove 32-1a on both side portions of the side plate 33, and the support protrusion 33-1a at both side ends of the side plate 33 are configured to be slidably to the support groove 32-1a of the supporter 32.

3. The aquarium having a filtering function of claim 1, wherein
the supporter 32 is configured in such a manner that one or more trapezoidal, circular, or oval support grooves 32-1b are provided at predetermined portions where both side ends of the side plate 33 are positioned, respectively, the side plate 33 is configured in such a manner that one or more support protrusions 33-1b correspondingly joined to the support grooves 32-1b, respectively are provided at both side ends of the side plate 33, the support protrusions 33-1b at both side ends of the side plate 33 are configured to be fittably joined to the support grooves 32-1b of the supporter 32 to configure the supporter 32 and the side plate 33 to be separated and joined.

4. The aquarium having a filtering function of claim 1, wherein
the filtering device 40 is configured to include: a hollow case 41 having a predetermined portion on an outer periphery at a predetermined portion of the horizontal partition 30, an inlet 41-1 for suck the water in the growing region 10 provided at an upper portion, and an outlet 41-2 for supplying the filtered water to the filtering region 11 provided at a lower portion; a filter 43 inserted into a hollow corresponding to the inlet 41-1 of the case 41 to filter the sucked water; a blocking net 44 having a plurality of bent pipes with a predetermined size and making the filtered water to penetrate in abutment of the bottom and the top of the filter 43; and a pump 45 which is positioned at a predetermined portion in the bottom direction of the blocking net, and is provided with a pump suction pipe 45-1 to suck the water penetrating the blocking net 44 and is provided with a pump discharge pipe 45-2 to discharge the water to the outlet 41-2 of the case 41.

5. The aquarium having a filtering function of claim 1, wherein
the aquarium 100 is configured to further include an auxiliary aquarium 101 having a lower water level surface than the aquarium 100 on any one side thereof, and a water stream movement hole 60 is provided at a predetermined portion corresponding to the water level surface of the aquarium 100 to allow the water in the aquarium 100 to flow into the auxiliary aquarium 101, a recovery hole 61 that receives the water from the auxiliary aquarium 101 and is connected with the filtering region 11 of the aquarium 100 is provided at a predetermined lower side position, the auxiliary aquarium 101 includes a porous horizontal partition 30′ that horizontally partitions an inner space of the auxiliary aquarium 101 having a predetermined shape into an upper growing region 10′ and a lower filtering region 11′, and a filtering device 40′ that is mounted on a predetermined portion of the horizontal partition 30′ and is provided with a filter to suck and filter water in the growing region 10′ and discharge the sucked and filtered water to the filtering region 11′, and the water discharged from the filtering device 40′ of the auxiliary aquarium 101 penetrates the filtering region 11′ of the auxiliary aquarium 101 and is supplied to the filtering region 11′ of the auxiliary aquarium 101 and the filtering region 11 of the aquarium 100 through a supply pipe 62 connected with the recovery hole 61.

6. The aquarium having a filtering function of claim 5, wherein
the aquarium 100 is configured not to include the filtering device 40.
